(19) United States
(12) Patent Application Publication
(10) Pub. No.: US 2025/0018518 A1
(43) Pub. Date: Jan. 16, 2025

(54) DEVICE AND METHOD FOR MANUFACTURING PHOTOSYNTHESIS AND DEMULTIPLEXING CIRCUIT

(71) Applicant: NIPPON TELEGRAPH AND TELEPHONE CORPORATION, Tokyo (JP)

(72) Inventors: Takui UEMATSU, Musashino-shi, Tokyo (JP); Kazutaka NOTO, Musashino-shi, Tokyo (JP); Hiroyuki IIDA, Musashino-shi, Tokyo (JP); Hidenobu HIROTA, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/711,957

(22) PCT Filed: Dec. 1, 2021
(86) PCT No.: PCT/JP2021/044035

§ 371 Date: May 21, 2024

(51) Int. Cl. B24B 13/00; C03C 25/005

(52) U.S. Cl. CPC B24B 13/00; C03C 25/005

(57) ABSTRACT

An object of the present disclosure is to provide an optical multiplexing/demultiplexing circuit manufacturing device and an optical multiplexing/demultiplexing circuit manufacturing method for polishing a portion of a side surface of an optical fiber core wire by a desired polishing amount without measuring optical loss by cutting an active optical fiber core wire.

To achieve the object described above, the optical multiplexing/demultiplexing circuit manufacturing device according to the present disclosure includes: an optical fiber core wire holding unit having a groove in which a portion of a side surface of an optical fiber core wire is embedded so as to protrude from an open plane by a predetermined distance; a polishing unit in which a polishing flat surface facing the open plane in parallel polishes the portion of the side surface of the optical fiber core wire; and a control unit that causes the polishing unit to start polishing the portion of the side surface of the optical fiber core wire and to finish polishing when the polishing flat surface of the polishing unit reaches the open plane.

### TECHNICAL FIELD

The present disclosure relates to an optical multiplexing/demultiplexing circuit manufacturing device and an optical multiplexing/demultiplexing circuit manufacturing method.

### BACKGROUND ART

There is a demand for an optical multiplexing/demultiplexing technique capable of demultiplexing light from an active optical fiber core wire and multiplexing light into the active optical fiber core wire without cutting the active optical fiber core wire.

As an optical multiplexing/demultiplexing technique, a method for manufacturing an optical fiber coupler using a side-polishing method has been studied (See, for example, Non Patent Literature 1). This optical fiber coupler manufacturing method is carried out by the following steps (1) to (3).

(1) An active optical fiber core wire is embedded in a groove formed in a holding unit having the groove designed for fitting an active optical fiber core wire therein, a side surface of the active optical fiber core wire is coated to a portion several μm apart from a core or to the core, and a cladding portion is polished.

(2) A side surface of an optical waveguide that is designed for optical multiplexing/demultiplexing embedded beforehand in a holding unit is coated to a portion several μm apart from a core or to the core, and a cladding portion is polished.

(3) The polished surface of the active optical fiber core wire subjected to side surface polishing and the polished surface of the optical waveguide that is designed for optical multiplexing/demultiplexing subjected to side surface polishing in advance are plane-aligned, and each of the holding units are moved in corresponding directions of the polished surfaces and fixed at positions where a desired branching ratio can be obtained.

### CITATION LIST

### Non Patent Literature

Non Patent Literature 1: Uematsu et al., “Study on optical fiber coupler using side-polishing method”, IEICE Technical Report, vol. 119, no. 223, OFT2019-36, pp. 23-26, October 2019

### SUMMARY OF INVENTION

### Technical Problem

In the related art, oil or liquid has conventionally been applied to the polished portion and an amount of increase in loss is measured in order to determine whether sufficiently polished to reach the core in step (1). There is a problem, however, that it is necessary to cut the active optical fiber core wire and connect a light source and a power meter thereto in order to measure the loss.

To solve the problem described above, an object of the present disclosure is to provide an optical multiplexing/demultiplexing circuit manufacturing device and an optical multiplexing/demultiplexing circuit manufacturing method for polishing a portion of a side surface of an optical fiber core wire by a desired polishing amount without measuring optical loss by cutting the active optical fiber core wire.

### Solution to Problem

To achieve the object described above, an optical multiplexing/demultiplexing circuit manufacturing device and an optical multiplexing/demultiplexing circuit manufacturing method according to the present disclosure polishes a portion of a side surface of an optical fiber core wire embedded in an optical fiber holding unit to an open plane such that a distance from an interface between a core and a cladding of the optical fiber core wire to the open plane of the optical fiber holding unit reaches a predetermined value.

Specifically, an optical multiplexing/demultiplexing circuit manufacturing device according to the present disclosure includes:
an optical fiber core wire holding unit having a groove in which a portion of a side surface of an optical fiber core wire is embedded so as to protrude from an open plane by a predetermined distance;
a polishing unit in which a polishing flat surface facing the open plane in parallel polishes the portion of the side surface of the optical fiber core wire; and
a control unit that causes the polishing unit to start polishing the portion of the side surface of the optical fiber core wire and to finish polishing when the polishing flat surface of the polishing unit reaches the open plane.

In the optical multiplexing/demultiplexing circuit manufacturing device according to the present disclosure,
the control unit may cause the polishing unit to finish polishing when a predetermined polishing time elapses after the polishing unit starts polishing.

The optical multiplexing/demultiplexing circuit manufacturing device according to the present disclosure may further include
a pressure measurement unit that measures a repulsive force received by the polishing unit from the optical fiber core wire and the optical fiber core wire holding unit, wherein
the control unit may cause the polishing unit to finish polishing when the repulsive force measured by the pressure measurement unit reaches a predetermined value or higher.

The optical multiplexing/demultiplexing circuit manufacturing device according to the present disclosure may further include:
an optical fiber core wire diameter measurement unit that measures a diameter of the optical fiber core wire;
a selection unit that selects, based on a pre-acquired correspondence relationship between the diameter of the optical fiber core wire and the predetermined distance for each of a plurality of the optical fiber core wire holding units each having the groove with different dimensions, the optical fiber core wire holding unit corresponding to the diameter of the optical fiber core wire measured by the optical fiber core wire diameter measurement unit; and
an embedding unit that embeds the optical fiber core wire in the groove of the selected optical fiber core wire holding unit.

Specifically, an optical multiplexing/demultiplexing circuit manufacturing method according to the present disclosure includes:
a selection step of selecting an optical fiber core wire holding unit having a groove in which an optical fiber core wire can be embedded such that a portion of a side surface of the optical fiber core wire protrudes from an open plane by a predetermined distance;
an embedding step of embedding the optical fiber core wire in the groove; and
a polishing step of starting polishing the portion of the side surface of the optical fiber core protruding from the open plane with a polishing flat surface of a polishing unit and finishing polishing with the polishing unit when the polishing flat surface of the polishing unit reaches the open plane of the groove.

In the optical multiplexing/demultiplexing circuit manufacturing method according to the present disclosure,
in the polishing step,
the polishing may be finished after an elapse of a predetermined polishing time from the start of the polishing.

In the optical multiplexing/demultiplexing circuit manufacturing method according to the present disclosure,
in the polishing step,
a repulsive force received by the polishing unit from the optical fiber core wire and the optical fiber core wire holding unit may be measured and the polishing may be finished when the measured repulsive force reaches a predetermined value or higher.

The optical multiplexing/demultiplexing circuit manufacturing method according to the present disclosure may further include
a preparation step and an optical fiber core wire diameter measurement step carried out before the selection step, wherein
the preparation step includes acquiring a correspondence relationship between a diameter of the optical fiber core wire and the predetermined distance for each of a plurality of the optical fiber core wire holding units each having a groove with different dimensions, and
the optical fiber core wire diameter measurement step includes measuring the diameter of the optical fiber core wire to be embedded in the optical fiber core wire holding unit, and
in the selection step,
the optical fiber core wire holding unit corresponding to the diameter of the measured optical fiber core wire is selected based on the correspondence relationship between the diameter of the optical fiber core wire and the predetermined distance.

Note that the inventions described above can be combined in any possible manner.

### Advantageous Effects of Invention

The present disclosure is capable of providing the optical multiplexing/demultiplexing circuit manufacturing device and the optical multiplexing/demultiplexing circuit manufacturing method for polishing the portion of the side surface of the optical fiber core wire by a desired polishing amount without measuring optical loss by cutting the active optical fiber core wire.

### BRIEF DESCRIPTION OF DRAWINGS

FIG. 1 illustrates an example of a schematic configuration of an optical multiplexing/demultiplexing circuit manufacturing device according to a first embodiment.

FIG. 2 illustrates an example of a sectional view of the optical multiplexing/demultiplexing circuit manufacturing device.

FIG. 3 illustrates an example of a sectional view of the optical multiplexing/demultiplexing circuit manufacturing device.

FIG. 4 illustrates an example of a sectional view of the optical multiplexing/demultiplexing circuit manufacturing device.

FIG. 5 is an explanatory diagram of changes in distance from an interface between a core and a cladding to a polishing flat surface.

FIG. 6 illustrates an example of a schematic configuration of an optical multiplexing/demultiplexing circuit manufacturing device according to a second embodiment.

FIG. 7 illustrates an example of a schematic configuration of an optical multiplexing/demultiplexing circuit manufacturing device according to a third embodiment.

### DESCRIPTION OF EMBODIMENTS

The following is a detailed description of embodiments of the present disclosure, with reference to the drawings. Note that the present disclosure is not limited to the following embodiments. These embodiments are merely examples, and the present disclosure can be carried out in forms of various modifications and improvements based on knowledge of those skilled in the art. Note that components denoted by the same reference sign in the description and the drawings are the same.

### First Embodiment

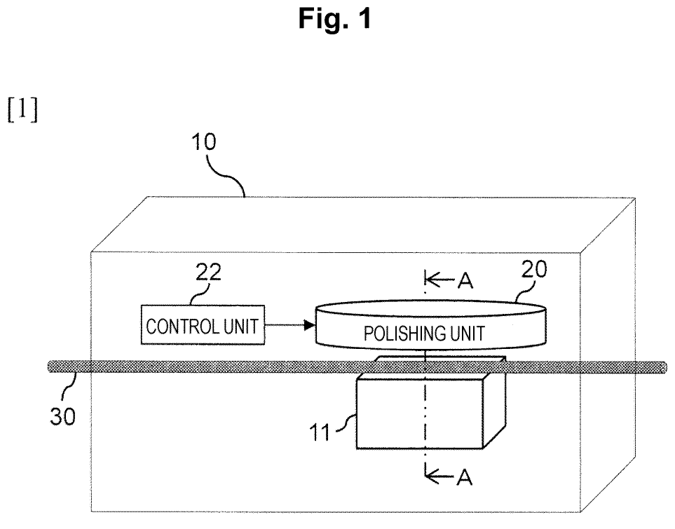

FIG. 1 illustrates an example of a schematic configuration of an optical multiplexing/demultiplexing circuit manufacturing device according to the present embodiment. An optical multiplexing/demultiplexing circuit manufacturing device 10 according to the present embodiment includes an optical fiber core wire holding unit 11, a polishing unit 20, and a control unit 22. In FIG. 1, the control unit 22 starts and finishes polishing, with the polishing unit 20, a side surface of an optical fiber core wire 30 embedded in the optical fiber core wire holding unit 11.

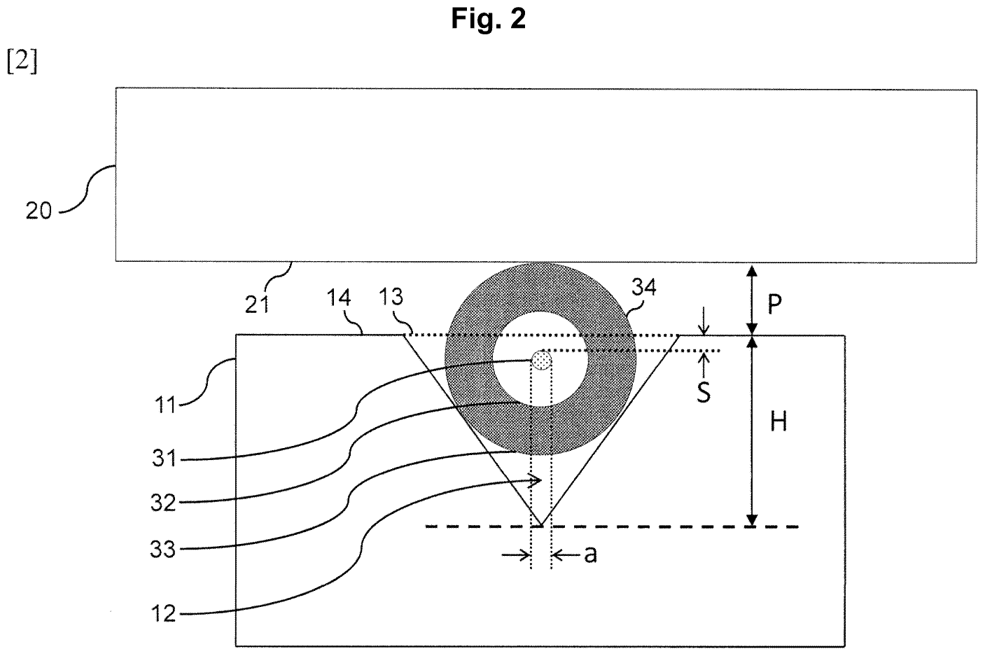

FIG. 2 illustrates a sectional view taken along line A-A in FIG. 1. The optical multiplexing/demultiplexing circuit manufacturing device 10 according to the present embodiment includes the optical fiber core wire holding unit 11 having a groove 12 in which the optical fiber core wire 30 is embedded such that a portion 34 of the side surface of the optical fiber core wire 30 protrudes from an open plane 13 by a predetermined distance P, the polishing unit 20 in which a polishing flat surface 21 facing the open plane 13 in parallel polishes the portion 34 of the side surface of the optical fiber core wire 30, and the control unit 22 that causes the polishing unit 20 to start polishing the portion 34 of the side surface of the optical fiber core wire 30 and to finish polishing when the polishing flat surface 21 of the polishing unit 20 reaches the open plane 13. The control unit 22 is illustrated in FIG. 1 but not illustrated in FIG. 2.

The optical fiber core wire holding unit 11 has, on a flat side surface of the optical fiber core wire holding unit 11, the groove 12 in which the optical fiber core wire 30 is embedded such that the portion 34 of the side surface of the optical fiber core wire 30 protrudes from the open plane 13 by a predetermined distance P. As illustrated in FIG. 2, a flat surface on both sides of the groove 12 is defined as a flat surface 14. The open plane 13 and the flat surface 14 are coplanar. The predetermined distance P is the shortest distance between the most distal end of the portion 34 of the side surface of the optical fiber core wire 30 protruding from the open plane 13 and the open plane 13. A distance S is the shortest distance from the interface between a core 31 and a cladding 32 of the embedded optical fiber core wire 30 to the open plane 13. The groove 12 has a depth and a shape such that the distance S is set to 0 to several micrometers.

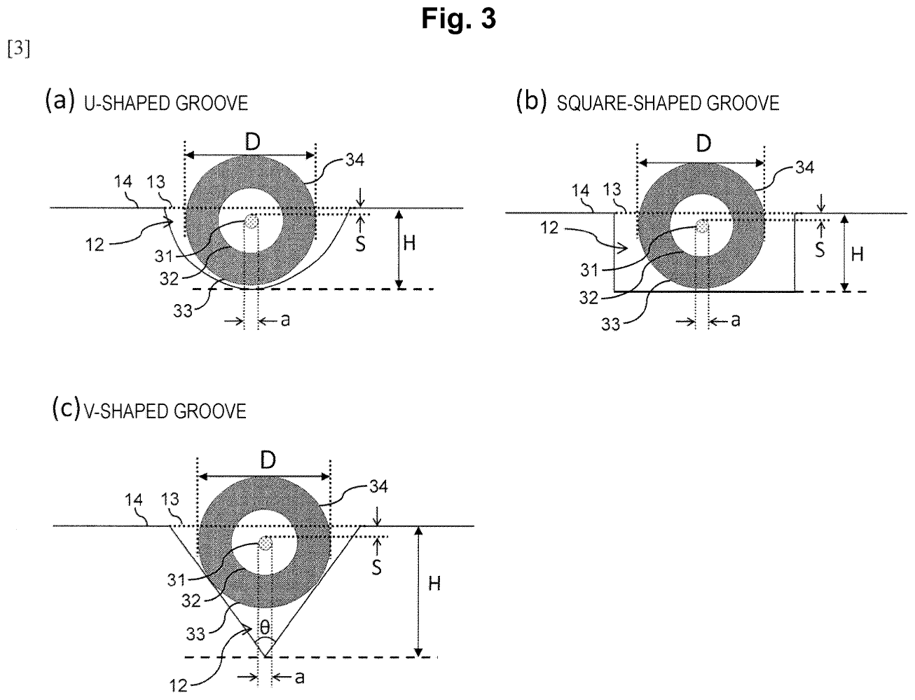

Examples of the shape of the groove 12 are illustrated in FIG. 3. A U-shaped groove is illustrated in (a) of FIG. 3. A square-shaped groove is illustrated in (b) of FIG. 3. A V-shaped groove is illustrated in (c) of FIG. 3. In the case of the groove 12 as illustrated in (a) or (b) of FIG. 3, for example, a depth H of the groove may be D/2+a/2+S, where D is a diameter of the optical fiber core wire and a is a diameter of the core 31. Alternatively, in the case of the groove 12 as illustrated in (c) of FIG. 3, a desired groove depth H may be obtained by S+a/2+D/[2 sin (θ/2)], where an angle of the V shape is 0. The shape of the groove 12 is not limited to the shapes illustrated in FIG. 3.

As illustrated in FIG. 2 the polishing unit 20 has the polishing flat surface 21 which faces the open plane 13 in parallel and polishes the portion 34 of the side surface of the optical fiber core wire 30.

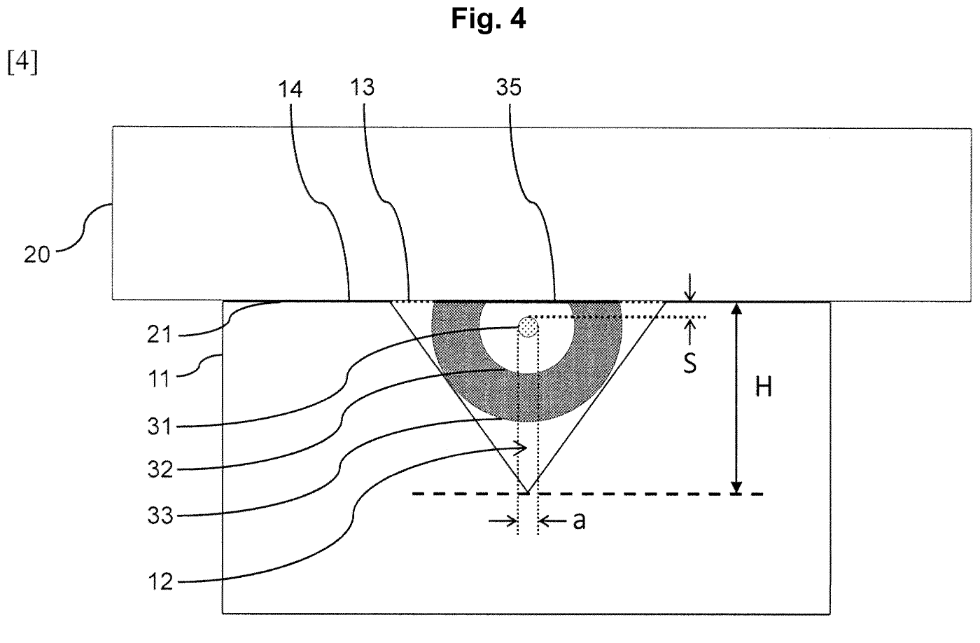

FIG. 4 illustrates a state in which the polishing flat surface 21 of the polishing unit 20 has reached the open plane 13. In FIG. 4, the portion 34 of the side surface of the optical fiber core wire 30 polished with the polishing unit 20 is a polished surface 35. When the polishing flat surface 21 of the polishing unit 20 reaches the open plane 13, the polishing flat surface 21 is in contact with the flat surface 14. The portion 34 of the side surface of the optical fiber core wire 30 is thus no longer polished after the polishing flat surface 21 reaches the open plane 13 and the polishing flat surface 21 is maintained at the position of the open plane 13. As a result, the polished surface 35 coincides with the open plane 13, which keeps the distance from the interface between the core 31 and the cladding 32 to the polished surface 35 constant at the distance S. It is possible to prevent the optical fiber core wire holding unit 11 itself from being polished by increasing hardness of the optical fiber core wire holding unit 11 or increasing a width of the flat surface 14 to sufficiently increase a contact area between the flat surface 14 and the polishing flat surface 21. As a result, the distance from the interface between the core 31 and the cladding 32 to the polished surface 35 can be kept constant at the distance S in a more stable manner. The width of the flat surface 14 refers to a direction perpendicular to a long axis direction of the groove 12.

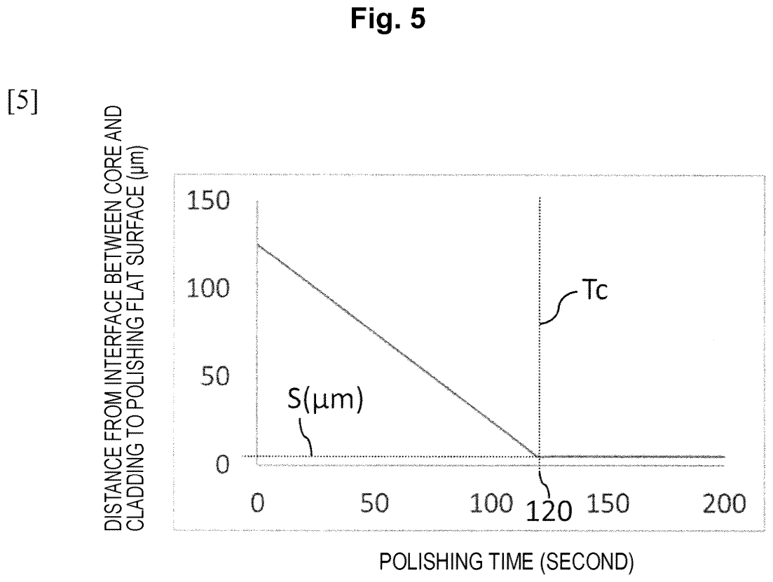

FIG. 5 illustrates a change in distance, with the elapse of a polishing time of the polishing unit 20, from the interface between the core 31 and the cladding 32 to the polishing flat surface 21. As illustrated in FIG. 5, the distance from the interface between the core 31 and the cladding 32 to the polishing flat surface 21 decreases with the elapse of the polishing time, but becomes constant after elapsing about 120 seconds. This is because, as shown in FIG. 4, the polishing flat surface 21 reaches the flat surface 14 after elapsing about 120 seconds, and the portion 34 of the side surface of the optical fiber core wire 30 is no longer polished. In the optical multiplexing/demultiplexing circuit manufacturing device 10 according to the present embodiment, the distance from the interface between the core 31 and the cladding 32 to the polished surface 35 can be thus set to a certain distance, such as the distance S, every time by polishing for a predetermined time (120 seconds in FIG. 5) or more. Hereinafter, the shortest polishing time among the polishing times in which the distance from the interface between the core 31 and the cladding 32 to the polishing flat surface 21 which can be regarded as constant is defined as a polishing time Tc. In FIG. 5, Tc is approximately 120 seconds.

The control unit 22 causes the polishing unit 20 to start polishing the portion 34 of the side surface of the optical fiber core wire 30 and to finish polishing when the polishing flat surface 21 of the polishing unit 20 reaches the open plane 13.

For example, the control unit 22 causes the polishing unit 20 to finish polishing after the elapse of the predetermined polishing time Tc from the start of the polishing.

The polishing time Tc varies depending on the material of the optical fiber core wire holding unit 11, polishing conditions (e.g., polishing rate, pressure, abrasive particle size, and the like), dimensions of the V-shaped groove, and diameters and types of the optical fiber core wire. The polishing time Tc may be thus obtained by determining these parameters, obtaining measurement results as shown in FIG. 5 by repeatedly polishing the portion 34 of the side surface of the optical fiber core wire 30 in advance with the optical multiplexing/demultiplexing circuit manufacturing device 10 according to the present embodiment using the parameters, and then setting as the polishing time Tc a value larger than the maximum value among the multiple obtained polishing times Tc.

The control unit 22 causes the polishing unit 20 to finish polishing at the polishing time Tc, thereby, for example, even when the material of the optical fiber core wire holding unit 11 is silicon, silica (quartz glass), or the like from the viewpoint of processing accuracy of the groove 12 and is slightly polished after the polishing flat surface 21 reaches the open plane 13, the distance from the interface between the core 31 and the cladding 32 to the polished surface 35 can be kept constant at the distance S. According to the present disclosure, therefore, the distance from the interface between the core 31 and the cladding 32 to the polished surface 35 can be set as a target value with good reproducibility.

In the present embodiment, the optical fiber core wire 30 has a coating 33; however, the optical multiplexing/demultiplexing circuit manufacturing device 10 according to the present embodiment can be also applied to the optical fiber core wire from which the coating 33 has been removed (with an outer diameter of 0.125 mm) as long as the optical fiber core wire has, after removal of the coating 33, the diameter D.

According to the present disclosure, when the polishing flat surface 21 of the polishing unit 20 reaches the open plane 13, the polishing finishes assuming that the portion 34 of the side surface of the optical fiber core wire 30 is polished by a desired polishing amount, which eliminates the need to monitor a polishing loss. It is therefore possible to provide the optical multiplexing/demultiplexing circuit manufacturing device and the optical multiplexing/demultiplexing circuit manufacturing method for polishing the portion of the side surface of the optical fiber core wire by a desired polishing amount without measuring optical loss by cutting the active optical fiber core wire.

### Second Embodiment

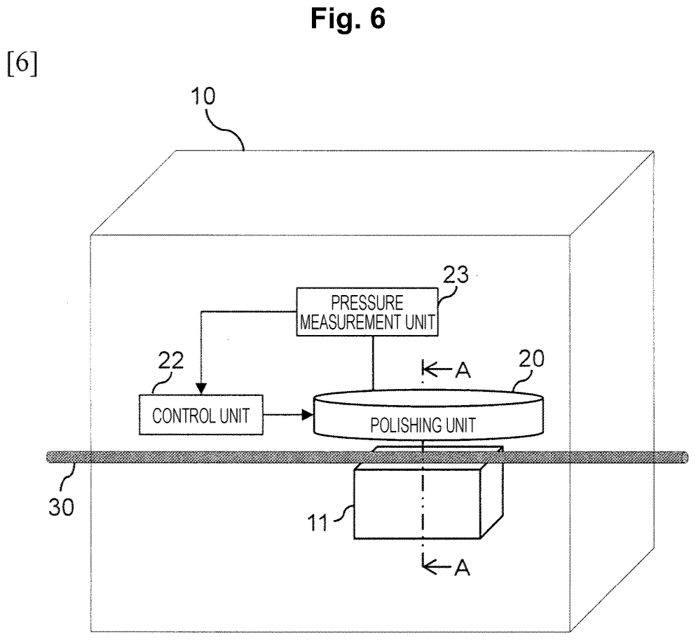

FIG. 6 illustrates an example of a schematic configuration of an optical multiplexing/demultiplexing circuit manufacturing device according to the present embodiment. An optical multiplexing/demultiplexing circuit manufacturing device 10 according to the present embodiment includes a means for causing a control unit 22 to cause a polishing unit 20 to finish polishing when a polishing flat surface 21 of the polishing unit 20 reaches an open plane 13.

Specifically, the optical multiplexing/demultiplexing circuit manufacturing device 10 according to the present embodiment further includes a pressure measurement unit 23 that measures a repulsive force received by the polishing unit 20 from an optical fiber core wire 30 and an optical fiber core wire holding unit 11, and the control unit 22 causes the polishing unit 20 to finish polishing when the repulsive force measured by the pressure measurement unit 23 reaches a predetermined value or higher. In the optical multiplexing/demultiplexing circuit manufacturing device 10 according to the present embodiment, the optical fiber core wire holding unit 11 and the polishing unit 20 are similar to those in the first embodiment.

As illustrated in FIG. 4, from the moment reaching the optical fiber core wire holding unit 11, the polishing flat surface 21 is in contact with not only a portion 34 of a side surface of the optical fiber core wire 30 but also a flat surface 14. This rapidly increases an area to be polished by the polishing unit 20, which rapidly increases the repulsive force. It is therefore possible to detect that the polishing flat surface 21 has reached the open plane 13 by measuring the repulsive force received by the polishing flat surface 21 from the optical fiber core wire 30 and the optical fiber core wire holding unit 11. Moreover, the rapid increase in the repulsive force is detected by a pressure sensor or the like and the control unit 22 causes the polishing unit 20 to finish polishing based on the detected result, whereby a distance from an interface between a core 31 and a cladding 32 to the polished surface 35 can be set as a target value with good reproducibility as in the first embodiment.

### Third Embodiment

The present embodiment describes an optical multiplexing/demultiplexing circuit manufacturing method including a step of selecting the optical fiber core wire holding unit 11 constituting the optical multiplexing/demultiplexing circuit manufacturing device 10 according to the first and second embodiments in accordance with a diameter D of an optical fiber core wire 30.

Specifically, the optical multiplexing/demultiplexing circuit manufacturing method according to the present embodiment may include a selection step of selecting the optical fiber core wire holding unit 11 having a groove 12 in which the optical fiber core wire 30 can be embedded such that a portion 34 of a side surface of the optical fiber core wire 30 protrudes from an open plane 13 by a predetermined distance P, an embedding step of embedding the optical fiber core wire 30 in the groove 12, and a polishing step of starting polishing the portion 34 of the side surface of the optical fiber core wire 30 protruding from the open plane 13 with the polishing flat surface 21 of a polishing unit 20 and finishing polishing with the polishing unit 20 when the polishing flat surface 21 of the polishing unit 20 reaches the open plane 13 of the groove 12.

The polishing step is a step carried out by the optical multiplexing/demultiplexing circuit manufacturing device 10 according to the first or second embodiments. That is, in the polishing step, the polishing may finish after an elapse of a predetermined polishing time from the start of the polishing as in the first embodiment.

Also in the polishing step, a repulsive force received by the polishing unit 20 from the optical fiber core wire 30 and the optical fiber core wire holding unit 11 may be measured and the polishing may finish when the measured repulsive force reaches a predetermined value or higher as in the second embodiment.

The optical multiplexing/demultiplexing circuit manufacturing method according to the present embodiment may further include, before the selection step, a preparation step of acquiring a correspondence relationship between the diameter D of the optical fiber core wire 30 and the predetermined distance P for each of a plurality of the optical fiber core wire holding unit 11 each having a groove 12 with different dimensions; and an optical fiber core wire diameter measurement step of measuring the diameter D of the optical fiber core wire 30 to be embedded in the optical fiber core wire holding unit 11. In the selection step, the optical fiber core wire holding unit 11 corresponding to the diameter D of the measured optical fiber core wire 30 may be selected based on the correspondence relationship between the diameter D of the optical fiber core wire 30 and the predetermined distance P.

Dimensions of the groove refer to the shape, depth, width, and the like of the groove. Examples of the shape of the groove include the shapes illustrated in FIG. 3. By preparing the plurality of optical fiber core wire holding units 11 having various grooves with different shapes, depths, widths, and the like, the predetermined distance P can be achieved even when the diameter D of the optical fiber core wire 30 varies.

In order to obtain the correspondence relationship between the diameter D of the optical fiber core wire 30 and the predetermined distance P, the predetermined distance P in a case where the optical fiber core wire 30, having the diameter D, embedded in the groove 12 is repeatedly acquired for multiple diameters D by measurement or calculation for each dimension of different grooves. The correspondence relationship between the diameter D and the predetermined distance P may be summarized in a table for each dimension of the grooves.

The diameter D of the optical fiber core wire 30 may vary from several micrometers to several tens of micrometers depending on a manufacturing error, a manufacturer, a manufacturing year, a laying environment, and the like. The optical multiplexing/demultiplexing circuit manufacturing device 10 and the optical multiplexing/demultiplexing circuit manufacturing method according to the present embodiment measures the diameter D of the optical fiber core wire 30, and selects, based on the diameter D, the optical fiber core wire holding unit 11 having a groove with a dimension in which a distance S from an interface between a core 31 and a cladding 32 of the optical fiber core wire 30 to the open plane 13 is 0 to several micrometers. As a result, even when the diameter D of the optical fiber core wire 30 varies, the optical fiber core wire holding unit 11 having a groove corresponding to the diameter D of the optical fiber core wire 30 can be selected, and the distance from the interface between the core 31 and the cladding 32 to the polished surface 35 can be set as a target value with good reproducibility.

### Fourth Embodiment

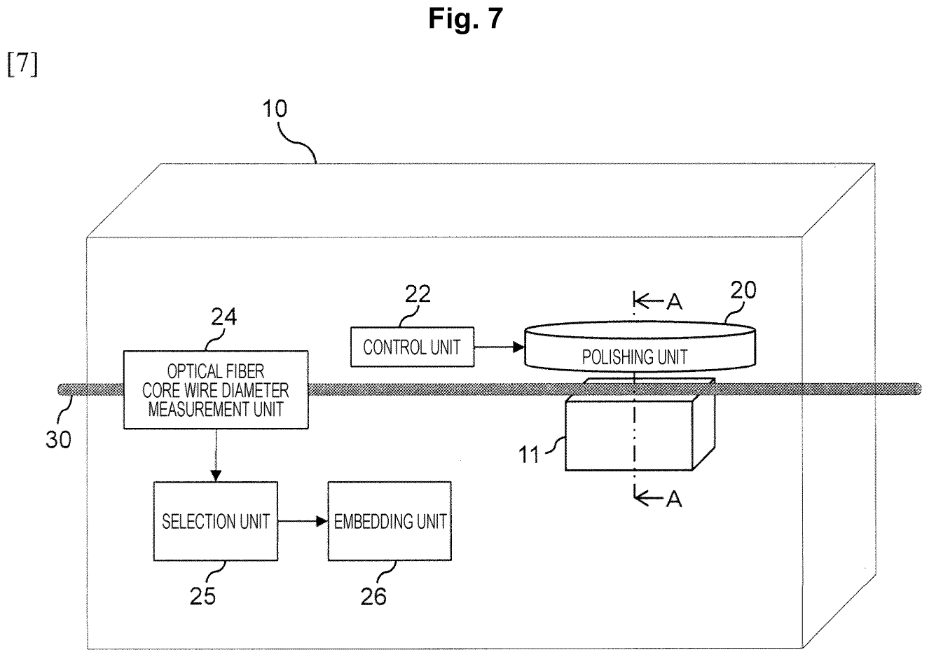

The selection step, the embedding step, the preparation step, and the diameter measurement step of the optical multiplexing/demultiplexing circuit manufacturing method according to the third embodiment may be carried out by an optical multiplexing/demultiplexing circuit manufacturing device 10. FIG. 7 illustrates an example of a schematic configuration of an optical multiplexing/demultiplexing circuit manufacturing device 10 according to the present embodiment.

Specifically, the optical multiplexing/demultiplexing circuit manufacturing device 10 according to the present embodiment may further include, an optical fiber core wire diameter measurement unit 24 that measures a diameter D of an optical fiber core wire 30, a selection unit 25 that selects, based on a pre-acquired correspondence relationship between the diameter D of the optical fiber core wire 30 and a predetermined distance for each of a plurality of optical fiber core wire holding units 11 each having a groove 12 with different dimensions, the optical fiber core wire holding unit 11 corresponding to the diameter D of the optical fiber core wire 30 measured by the optical fiber core wire diameter measurement unit 24, and an embedding unit 26 that embeds the optical fiber core wire 30 in the groove 12 of the selected optical fiber core wire holding unit 11.

The diameter D of the optical fiber core wire 30 may vary from several micrometers to several tens of micrometers depending on a manufacturing error, a manufacturer, a manufacturing year, a laying environment, and the like. The optical multiplexing/demultiplexing circuit manufacturing device 10 and the optical multiplexing/demultiplexing circuit manufacturing method according to the present embodiment measures the diameter D of the optical fiber core wire 30, and selects, based on the diameter D, the optical fiber core wire holding unit 11 having a groove with a dimension in which a distance S from an interface between a core 31 and a cladding 32 of the optical fiber core wire 30 to the open plane 13 is 0 to several micrometers. As a result, even when the diameter D of the optical fiber core wire 30 varies, the optical fiber core wire holding unit 11 having a groove corresponding to the diameter D of the optical fiber core wire 30 can be selected, and the distance from the interface between the core 31 and the cladding 32 to the polished surface 35 can be set as a target value with good reproducibility.

With the optical multiplexing/demultiplexing circuit manufacturing device 10 according to the present embodiment, it is possible to automatically carry out from selecting of the optical fiber core wire holding unit 11 corresponding to the diameter of the optical fiber core wire to finishing polishing a portion 34 of a side surface of the optical fiber core wire 30.

### INDUSTRIAL APPLICABILITY

The optical multiplexing/demultiplexing circuit manufacturing device and the optical multiplexing/demultiplexing circuit manufacturing method according to the present disclosure can be applied to the information communication device industry.

### REFERENCE SIGNS LIST

10 Optical multiplexing/demultiplexing circuit manufacturing device
11 Optical fiber core wire holding unit
12 Groove
13 Open plane
14 Flat surface
Polishing unit
21 Polishing flat surface
22 Control unit
23 Pressure measurement unit
24 Optical fiber core wire diameter measurement unit
25 Selection unit
26 Embedding unit
30 Optical fiber core wire
31 Core
32 Cladding
33 Coating
34 Portion of side surface
Polished surface
H Groove depth
D Diameter of optical fiber core wire
a Core diameter
S Distance
θ V-shaped corner
P Predetermined distance

1. An optical multiplexing/demultiplexing circuit manufacturing device comprising:
an optical fiber core wire holding unit having a groove in which a portion of a side surface of an optical fiber core wire is embedded so as to protrude from an open plane by a predetermined distance;
a polishing unit in which a polishing flat surface facing the open plane in parallel polishes the portion of the side surface of the optical fiber core wire; and
a control unit that causes the polishing unit to start polishing the portion of the side surface of the optical fiber core wire and to finish polishing when the polishing flat surface of the polishing unit reaches the open plane.

2. The optical multiplexing/demultiplexing circuit manufacturing device according to claim 1, wherein
the control unit causes the polishing unit to finish polishing after an elapse of a predetermined polishing time from the start of the polishing.

3. The optical multiplexing/demultiplexing circuit manufacturing device according to claim 1, further comprising
a pressure measurement unit that measures a repulsive force received by the polishing unit from the optical fiber core wire and the optical fiber core wire holding unit, wherein
the control unit causes the polishing unit to finish polishing when the repulsive force measured by the pressure measurement unit reaches a predetermined value or higher.

4. The optical multiplexing/demultiplexing circuit manufacturing device according to claim 1, further comprising:
an optical fiber core wire diameter measurement unit that measures a diameter of the optical fiber core wire;
a selection unit that selects, based on a pre-acquired correspondence relationship between a diameter of the optical fiber core wire and the predetermined distance for each of a plurality of the optical fiber core wire holding units each having the groove with different dimensions, the optical fiber core wire holding unit corresponding to the diameter of the optical fiber core wire measured by the optical fiber core wire diameter measurement unit; and
an embedding unit that embeds the optical fiber core wire in the groove of the selected optical fiber core wire holding unit.

5. An optical multiplexing/demultiplexing circuit manufacturing method comprising:
a selection step of selecting an optical fiber core wire holding unit having a groove in which an optical fiber core wire can be embedded such that a portion of a side surface of the optical fiber core wire protrudes from an open plane by a predetermined distance;
an embedding step of embedding the optical fiber core wire in the groove; and
a polishing step of starting polishing the portion of the side surface of the optical fiber core protruding from the open plane with a polishing flat surface of a polishing unit and finishing polishing with the polishing unit when the polishing flat surface of the polishing unit reaches the open plane of the groove.

6. The optical multiplexing/demultiplexing circuit manufacturing method according to claim 5, wherein
in the polishing step,
the polishing is finished after an elapse of a predetermined polishing time from the start of the polishing.

7. The optical multiplexing/demultiplexing circuit manufacturing method according to claim 5, wherein
in the polishing step,
a repulsive force received by the polishing unit from the optical fiber core wire and the optical fiber core wire holding unit is measured and the polishing is finished when the measured repulsive force reaches a predetermined value or higher.

8. The optical multiplexing/demultiplexing circuit manufacturing method according to claim 5, further comprising, before the selection step:
a preparation step of acquiring a correspondence relationship between a diameter of the optical fiber core wire and the predetermined distance for each of a plurality of the optical fiber core wire holding units each having a groove with different dimension; and
an optical fiber core wire diameter measurement step of measuring the diameter of the optical fiber core wire to be embedded in the optical fiber core wire holding unit, wherein
in the selection step,
the optical fiber core wire holding unit corresponding to the diameter of the measured optical fiber core wire is selected based on the correspondence relationship between the diameter of the optical fiber core wire and the predetermined distance.
